(19) United States
(12) Patent Application Publication
(10) Pub. No.: US 2015/0307814 A1
(43) Pub. Date: Oct. 29, 2015

(54) DETERGENT FORMULATION

(71) Applicant: RECKITT BENCKISER N.V., Hoofddorp (NL)

(72) Inventors: Stuart CAMPBELL, Ludwigshafen (DE); Laurent KIRCHHOFFER, Bangpakong (TH); Pavlinka ROY, Ludwigshafen (DE); Dietmar VAN LOYEN, Ludwigshafen (DE)

(21) Appl. No.: 14/424,711

(22) PCT Filed: Sep. 9, 2013
(86) PCT No.: PCT/GB2013/052356

§ 371 Date: Feb. 27, 2015

(30) Foreign Application Priority Data
Sep. 7, 2012 (GB) 1216028.9
Feb. 15, 2013 (GB) 1302688.5

(51) Int. Cl. C11D 3/20; C11D 17/00

(52) U.S. Cl. CPC C11D 3/2082; C11D 17/0004

(57) ABSTRACT

The present invention provides a non-aqueous liquid, gel or paste composition, comprising a colourant and methylglycine diacetic acid (MGDA) or a salt thereof. The compositions afford enhanced stability of the colourant in the presence of MGDA. The invention also provides a unit dose detergent product comprising the inventive composition, a washing or cleaning process that utilizes this composition or product, and the use of this composition or product for washing or cleaning.

### TECHNICAL FIELD

The present invention relates to a coloured formulation comprising methylglycine-N,N-diacetic acid (MGDA, also known as α-alanine-N,N-diacetic acid) or a salt thereof, with enhanced stability including of the colourant species itself. The present invention also relates to the use of the formulation as a detergent, e.g. in laundry or dishwashing applications.

### BACKGROUND

One component typically present in a laundry or automatic machine dishwashing detergent is a builder. This is a complexing or chelating agent used to aid the removal or capture of metal ions in aqueous solution. With its use, deposits of metal ion-based sediments, such as limescale, within automatic washing machines are reduced and the cleaning process is enhanced (certain stains incorporate a metal ion component, e.g. tea stains which comprise a calcium/tannin complex).

Historically, phosphate-based compounds have been the mainstay of detergent builders, but there is an increasing environmental and regulatory drive to develop phosphate-free detergents.

MGDA is a phosphate-free builder whose prominence in the detergent field is rising (c.f. WO 94/29421, for instance). The combination of its excellent cleaning performance even in hard water conditions, and economical availability, confers advantages over other P-free builders. MGDA has the chemical structure:

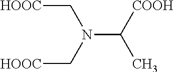

MGDA is water soluble and generally synthesized in aqueous solution; it is commercially available as a 40% aqueous solution of the trisodium salt (Trilon™ M Liquid from BASF Corporation), as well as in solid forms obtained from this aqueous solution (e.g. Trilon™ M Powder, Trilon™ M Granules, also from BASF Corporation). The solid forms have a white or pale yellowish colour, whereas the aqueous solution is clear or yellowish. Many other commonly used detergent ingredients also are not strongly coloured. For a consumer product, such as a laundry or dishwashing detergent, there is a commercial drive for coloured formulations that are attractive to the consumer. Accordingly, dyes or pigments can be incorporated into MGDA-containing formulations.

In preparing various different types of coloured formulations, however, the present inventors have noticed significant problems with stability of the colour that occur specifically with MGDA-containing formulations. This can, for instance, be manifested as a change in colour or hue of the formulation over time, either homogeneously or via the appearance of differently-coloured “speckles” or “blotches” in an originally uniform formulation. Such problems do not seem to have been previously recognised in the art.

For instance, WO 2012/025740 discloses a detergent composition comprising MGDA, manganese oxalate and a bleach. There is no specific mention of dyes or pigments in the composition. Various other documents disclose detergent formulations comprising a long list of optional ingredients, amongst which can be found MGDA and dyes/pigments. Nevertheless, these documents lack a specific disclosure of a composition containing MGDA and a dye/pigment, and discussion of colour stability issues with the latter.

The inventors' studies have revealed that their observed problems with colour stability can surprisingly be associated with water in the formulation. Solid forms of MGDA obtained from the aqueous solution are often hydrates; amorphous solid forms, especially fine particulate powder forms made by spray drying, are also generally hygroscopic. Thus, it is known that upon storage, the MGDA can absorb water from the atmosphere, as discussed in WO 2009/103822. The skilled person might assume that this absorbed water would do little harm to the colourant species; the worst that would happen would be that dyes are partially dissolved into the absorbed water. However, the colour stability of a significant proportion of formulations of this type was found to be poor, so it must be presumed that a chemical reaction is occurring upon water absorption, and not simply a physical change, though the inventors were not able to predict the colour stability based on knowledge of the chemical nature of the colourant.

The inventors found the problem of poor colour stability to be exacerbated in the aqueous gel format, but not seen if the composition is formulated as a non-aqueous liquid, gel, or paste.

The reason for this has not been fully elucidated; a number of factors may be involved. From the perspective of chemical reactivity, solid MGDA is known to be relatively stable when stored in isolation under dry, cold conditions. As discussed in U.S. Pat. No. 7,671,234, however, processes used for the synthesis of MGDA, which generally terminate in alkaline hydrolysis of methylglycinediacetonitrile (MGDN), may generate a number of impurities in the final product. MGDN is quite thermally labile in alkaline solution, and dissociation and side reactions may produce by-products such as cyanide, acetaldehyde, iminodiacetonitrile, formaldehyde, iminodiacetate, nitrilotriacetate, carbonate, acetate, formate, glycolate, lactate, glycinate and/or alaninate.

Without wishing to be bound by theory, it is possible that one or more residual impurities from the original MGDA synthesis may be susceptible to reaction with dye or pigment species. In the case of a solid formulation, the water absorbed by the MGDA upon storage may dissolve water-soluble impurities, bringing them in closer proximity to the dye or pigment and facilitating their interaction. This would be heightened in the case of an aqueous formulation. Alternatively or in addition, the MGDA molecule itself may be susceptible to reaction with the colourant, with water being a catalyst or means to lower the kinetic barrier to reaction. Provision of the MGDA in a non-aqueous, non-solid matrix, e.g. a liquid, gel or paste composition, shields the MGDA from the atmosphere so that absorption of moisture is inhibited. It is also hypothesized that the problematic impurities in the MGDA raw material, and/or the MDGA itself, are insoluble in the non-aqueous liquid, such that they are less mobile and reaction with colourant species in the formulation may be hindered.

Whatever the mechanism, the inventors' work has led to the provision of coloured MGDA-containing formulations which are stable, and more particularly colour stable, upon storage.

### SUMMARY OF THE INVENTION

In a first aspect of the invention there is provided a non-aqueous liquid, gel or paste composition, comprising a colourant and methylglycine diacetic acid or a salt thereof.

In a second aspect of the invention there is provided a unit dose detergent product, comprising a composition according to the invention in its first aspect.

In a third aspect of the invention there is provided a washing or cleaning process, which utilizes the composition according to the invention in its first aspect or the product according to the invention in its second aspect.

In a fourth aspect of the invention there is provided the use of the composition according to the invention in its first aspect or the product according to the invention in its second aspect for washing or cleaning.

### DETAILED DESCRIPTION

Herein, reference to MGDA is intended to include reference to salt(s) thereof, unless otherwise specified or the context otherwise requires. Reference to a colourant is intended to include reference to a dye (water-soluble) or a pigment (water-insoluble), unless otherwise specified or the context otherwise requires.

The inventive formulation is non-aqueous in the sense that it is substantially water-free. Preferably it contains no more than 20% by weight water, preferably no more than 15%, 13%, 10%, 7%, 5%, 3%, 2% or 1% water, and preferably contains no water beyond that which is entrained with other ingredients of the formulation. The skilled person will appreciate that the presence of small amounts of water in the formulation may be unavoidable, e.g. due to water in the raw ingredients. For instance, commercially available MGDA granules may contain around 13% by weight water.

In the present invention, the MGDA itself (regardless of the state of dissolution of the impurities) may be dissolved or not dissolved in the non-aqueous phase. However, it is preferably not dissolved in the non-aqueous phase. In an embodiment, MGDA is dispersed or suspended in a non-aqueous fluid in which it is insoluble or sparingly soluble, preferably insoluble, to form a composition taking the form of a liquid (dispersion/suspension) or paste according to the conventional definitions. In another embodiment, the composition is a gel containing dispersed/suspended particulate MGDA.

The MGDA and colourant are preferably present in different phases of the composition. For instance, they may be dispersed or suspended separately in the non-aqueous phase. Alternatively, the MGDA may be dispersed/suspended in the non-aqueous phase, with the colourant dissolved in the non-aqueous phase. It is hypothesized that the non-aqueous liquid separates the MGDA (molecule and/or impurities) from the colourant species on a microscopic level, or at least limits their contact, so as to hinder their reaction with each other.

When the colourant is in a particulate phase, the particles may comprise or consist of colourant, e.g. the particles may be pigment particles or dyed particles of another ingredient of the formulation. If the particles contain a second (non-colourant) ingredient, in an embodiment the particles contain at least 80%, preferably 85%, 90%, 95%, 98% or 99% by weight of colourant. Preferably the colourant particles are non-coated, or colourant is present on the surface of the particles.

It has been found that MGDA particles themselves generally exhibit poor or inhomogeneous uptake of dyes, whereas other elements of the formulation may take up the dyes well. Comparative coloured MGDA-containing solid formulations may therefore have a “speckled” appearance due to the mixture of pigment particles, or dyed particles of other ingredients, with the less intensely coloured MGDA particles. An additional benefit of embodiments of the present invention is that the formulation appears to the eye to have a consistent, uniform colour rather than a “speckled” appearance. With a solid formulation, there are difficulties in achieving the desirable uniform appearance by using an appropriately small particle size of both the MGDA and the coloured particles (and ensuring that the coloured particles are evenly distributed throughout the formulation and intimately mixed with the MGDA), because the opportunities for reducing the MGDA particle size are limited due to the increase in hygroscopicity as discussed above.

In the present invention, at least one colourant is present in the composition. Mixtures of colourants may also be used if desired. Any suitable colourant may be used. Preferably it is a water-soluble colourant and/or soluble in the non-aqueous matrix. Preferably it is hydrophilic. Preferably the colourant has an n-octanol/water partition coefficient at 20° C. of ≦1000, ≦100, or ≦10 (log P_{OW}≦3, ≦2, or ≦1), as measured according to the standard method in the art.

The colourant may be an organic or an inorganic species. Organic colourants, however, may be susceptible to greater stability issues in MGDA-containing formulations than inorganic ones. In an embodiment, the colourant is an organic species. In an embodiment, the colourant is a dye. In an embodiment the dye is dissolved in the non-aqueous phase.

The colourant may be metal ion-containing or metal ion free. MGDA itself may be liable to chelate the metal ion of metal ion-containing colourants, so separating MGDA and metal-ion colourants into different phases can prevent this. However, since the inventors saw stability problems also with colourants that are free of metal ions, this is not thought to be the sole source of colour instability.

The colourant may be an acidic, basic or neutral compound, cationic or anionic, aromatic or non-aromatic. It may be an azo-, carbonyl- and/or sulphur-containing compound. For instance, it may be an arylmethane (e.g. triarylmethane or diarylmethane) dye, anthraquinone dye, azo dye, phthalocyanine dye, nitroso dye, quinone-imine dye, thiazole dye, or xanthene dye. Examples include Sanolin™ Blue NBL (Acid Blue 80), Sanolin™ Ponceau 4RC 82 (Acid Red 18), Lanasyn™ Blue F-2RFL 160 (Acid Blue 225), and Sanolin™ Green R-3GL (Reactive Green 12), all available from Clariant International Ltd. Other colourants from the Sanolin™ and Lanasyn™ range are also suitable. Other examples include Iragon™ Blue ABL 9 (Acid Blue 9) from Ciba/BASF Corporation, Ariabel™ Rubicon (D&C Red 7) from Sensient Industrial, Cosmetic Red 3B (100% C.I. Pigment Red 57:1) from Clariant International Ltd. and Puricolor Red Frel (FD&C No. 4) from BASF Corporation.

The colour of the colourant is not important for the invention.

The colourant(s) may be incorporated in the inventive composition in any suitable amount, for instance 0.001% to 3% by weight, 0.005% to 2% by weight, or 0.01-1% by weight of the composition.

Whilst improvements in the synthesis of MGDA are being made in the art, a highly pure MDGA form has still not been produced economically on a large scale. Whilst it may be possible to produce MGDA in grades of higher purity, the resulting product is much more expensive. Similarly, due to the lower surface area, granulate MGDA tends to be less hygroscopic than the powder version, but still suffers from this problem to an extent over longer storage periods. Crystalline MGDA is even less hygroscopic, but can be difficult to produce economically. Thus, whilst it the present invention is not limited to the use of MGDA forms having a hygroscopicity or purity in a particular range, an added benefit of the invention is that it allows the possibility of using cheaper, less pure grades of MGDA without compromising colour stability.

Thus, the inventive composition may be produced from granules comprising MGDA. In a preferred embodiment, however, powdered MGDA is used directly, without prior granulation. Preferably, the source of MGDA is a spray-dried powder. In an embodiment, the particles comprising MGDA have an average particle size less than 1000 μm.

In an embodiment, the MGDA raw material used in the formulation has a purity of ≦90%, ≦85%, ≦80%, or ≦75%, by weight. In an embodiment, the MGDA solid raw material used in the formulation contains 75-90%, 80-89%, or 85-88%, by weight MGDA, calculated as the trisodium salt; 5-20%, 6-10%, or 7-9%, by weight water; and at least 3%, 4-15%, or 5-7%, by weight (non-water) impurities.

Particulate MGDA that is at least partially coated with a water soluble/dispersible material may be used in the present invention, e.g. the coated MGDA disclosed in U.S. Pat. No. 7,935,668. However, coating of MGDA particles involves an extra processing step and is not needed to achieve the advantages of the present invention. In an embodiment of the invention in which the composition comprises dispersed/suspended particles comprising MGDA, these particles are uncoated.

On the other hand, use of MGDA co-granulated with at least one other substance or formulated with at least one other substance as an excipient, such that the MGDA and other substance(s) are homogeneously mixed within each particle, is within the scope of the invention. Preferably the co-granulant(s) or excipient(s) make up no more than 10%, 8%, 6%, 4%, 2% or 1% by weight of said particles (the rest being MGDA, any impurities and optionally water). Preferably the co-granulant(s) and excipient(s) do not include a colourant.

In an embodiment, the composition contains dispersed/suspended particles that consist of MGDA, i.e. contain no other species save for any residual impurities from the MGDA manufacture and any entrained water.

In use of the inventive composition in detergent applications, the MGDA acts as a complexing agent to form water-soluble complexes with polyvalent ions, such as alkaline earth metal ions and heavy metal ions, particularly calcium and magnesium ions. If a salt form of MGDA is used, therefore, this is desirably a salt which is sufficiently soluble in water to allow it to perform its complexing function. In an embodiment, the salt is an alkali metal, ammonium or substituted ammonium salt, preferably a sodium, potassium or ammonium salt, preferably the trisodium, tripotassium or triammonium salt, preferably the trisodium salt. Mixtures of such salts may also be used.

The amount of MGDA used in the detergent composition of the present invention may suitably be between 5% and 95% by weight, preferably between 10% and 90%, between 15% and 85%, between 20% and 80%, between 25% and 75%, between 30% and 70%, between 35% and 65%, between 40% and 60%, or between 45% and 55% by weight of the composition.

The non-aqueous carrier for the inventive composition may comprise one or more organic solvents, preferably polar organic solvents. Examples include monohydric alcohols (e.g. lower aliphatic alcohols), diols (e.g. 1,2-propanediol, 1,3-propanediol), polyols (e.g. glycerol), and polyethers (e.g. polyethylene glycol). Other suitable hydrophilic solvents are within the knowledge of the skilled person.

Preferably, the non-aqueous carrier comprises a surfactant. In an embodiment, at least 70% by weight of the liquid components of the composition (at 20° C.) is surfactant(s), preferably at least 80%, 85%, 90% or 95% by weight of the composition. In an embodiment, the non-aqueous liquid consists essentially of surfactant(s). Other ingredients of the formulation may be pre-dissolved in other non-aqueous carriers, however; for instance 1,2-propylene glycol may be a carrier for the colourant. In this embodiment, therefore, relatively small amounts of such solvents may still be found in the final composition.

The four main classes of surfactants are anionic, cationic, amphoteric and non-ionic. Non-ionic surfactants are preferred especially for automatic dishwashing (ADW) detergents since they are defined as low foaming surfactants. For laundry and cleaning applications (excluding automatic dishwashing), other surfactants such as anionic surfactants are preferably included.

Surfactants which are solid at 20° C. may also be incorporated into the composition of the invention.

Suitable surfactants are within the general knowledge of the skilled person, and described for instance in Kirk Othmer's Encyclopedia of Chemical Technology, 3rd Ed., Vol. 22, pp. 360-379, “Surfactants and Detersive Systems”, incorporated by reference herein.

A non-ionic surfactant structure may be based on a fatty alcohol with a carbon C₈ to C₂₀ chain, wherein the fatty alcohol has been ethoxylated or propoxylated. The degree of ethoxylation is described by the number of ethylene oxide units (EO), and the degree of propoxylation is described by the number of propylene oxide units (PO). Surfactants may also comprise butylene oxide units (BO) as a result of butoxylation of the fatty alcohol. Preferably, this will be a mix with PO and EO units. The surfactant chain can be terminated with a butyl (Bu) moiety.

Surfactants which are ethoxylated mono-hydroxy alkanols or alkylphenols which additionally comprise poly-oxyethylene-polyoxypropylene block copolymer units may be used. The alcohol or alkylphenol portion of such surfactants constitutes more than 30%, preferably more than 50%, more preferably more than 70% by weight of the overall molecular weight of the non-ionic surfactant.

Another class of suitable non-ionic surfactants includes reverse block copolymers of polyoxyethylene and poly-oxypropylene and block copolymers of polyoxyethylene and polyoxypropylene initiated with trimethylolpropane.

Another group of preferred non-ionic surfactants are the end-capped polyoxyalkylated non-ionics of formula:

R₁O[CH₂CH(R₃)O]ₓ[CH₂]ₖCH(OH)[CH₂]ⱼOR₂

where R₁ and R₂ represent linear or branched chain, saturated or unsaturated, aliphatic or aromatic hydrocarbon groups with 1-30 carbon atoms, R₃ represents a hydrogen atom or a methyl, ethyl, n-propyl, iso-propyl, n-butyl, 2-butyl or 2-methyl-2-butyl group, x is a value between 1 and 30 and, k and j are values between 1 and 12, preferably between 1 and 5. When the value of x is >2 each R₃ in the formula above can be different. R₁ and R₂ are preferably linear or branched chain, saturated or unsaturated, aliphatic or aromatic hydrocarbon groups with 6-22 carbon atoms, where group with 8 to 18 carbon atoms are particularly preferred. For the group R₃═H, methyl or ethyl are particularly preferred. Particularly preferred values for x are comprised between 1 and 20, preferably between 6 and 15.

Other suitable surfactants are disclosed in WO 95/01416, to the contents of which express reference is hereby made.

Examples of especially preferred non-ionic surfactants are the Plurafac™, Lutensol™ and Pluronic™ range from BASF and Genapol™ series from Clariant.

In the second aspect of the invention, the composition is provided in unit dose detergent form, e.g. in a sachet, capsule, or blister. The unit dose product may be made by any suitable method known to the art e.g. thermoforming, vacuum-forming or injection moulding. The walls of the unit dose product may be made of any suitable material, e.g. a water soluble or water dispersible material, but are preferably made of a water soluble material such as PVOH (polyvinyl alcohol). It may be a single-compartment or multi-compartment product. If the latter, only one compartment, or more than one compartment, may independently contain a composition of the invention. Any compartments that are not filled with a composition of the invention may contain another suitable formulation, e.g. a powder or compressed solid, or a prior art gel, paste or liquid.

Multi-compartment products have been used in the past to segregate incompatible ingredients or to achieve different aesthetic effects. When an ingredient is incompatible with a colourant, it might be thought to make fewer than all of the compartments coloured, and include the incompatible ingredient in a white composition in a separate compartment. However, in the case of MGDA, competing factors present an issue: the overall size of the product may be limited e.g. by the size of the dishwashing machine compartment into which it must fit, whereas the total amount of MGDA that must be included in the product may be very high in order to achieve the desired performance. This may mean that, in practice, MGDA needs to be incorporated in all available compartments of the product. Thus, unless the colour stability issue is solved, colourant cannot be included in any of the compartments.

Optional additional components of the inventive composition, or optional components of another composition in the inventive unit dose product, are detailed below.

Bleach

Any conventional bleaching compound can be used in any conventional amount in either the composition of the invention or in another composition forming part of the multi-compartment unit dose product. A combination of bleaching compounds can also be used.

In an embodiment, the composition of the invention does not comprise bleach (or does not comprise at least one of the bleaches discussed below, for instance does not comprise an inorganic perhydrate). In an embodiment, the unit dose product contains a composition of the invention which lacks bleach (or lacks at least one of the bleaches discussed below, for instance does not comprise an inorganic perhydrate), but also contains a composition not of the invention which does comprise bleach (or comprises said bleach that is lacking from the inventive composition).

The bleach may depend on hydrogen peroxide or percarbonate as a hydrogen peroxide source. Most preferably the bleach is selected from inorganic peroxy-compounds and organic or inorganic peracids and the salts derived therefrom. Examples of inorganic perhydrates include perborates or percarbonates. The inorganic perhydrates are normally alkali metal salts, such as lithium, sodium or potassium salts, in particular sodium salts. The inorganic perhydrates may be present as crystalline solids without further protection. However, for certain perhydrates it is advantageous to use them in granular form provided with a coating which gives the granules a greater stability. This coating may also comprise colourant, or colourant may be applied to the coated bleach particles, as described in WO 2012/066344 (incorporated by reference herein). The preferred percarbonate is sodium percarbonate, preferably in coated form, preferably in the form of coloured particles.

Inorganic peracids include persulfates such as potassium peroxymonopersulfate (KMPS).

Organic peracids include all organic peracids traditionally used as bleaches, including, for example, perbenzoic acid and peroxycarboxylic acids such as mono- or diperoxyphthalic acid, 2-octyldiperoxysuccinic acid, diperoxydodecanedicarboxylic acid, diperoxyazelaic acid and imidoperoxycarboxylic acid and, optionally, the salts thereof. Especially preferred is phthalimidoperhexanoic acid (PAP).

Bleach Activators

Generally the use of a bleach activator in a detergent composition leads to a significant reduction in the effective washing temperature. Compositions of the present invention, or compositions present in the unit dose product of the invention, may therefore comprise one or more bleach activators if desired.

Any suitable bleach activator or combination of bleach activators may be included. A non-limiting example of a bleach activator is tetra acetylethylenediamine (TAED).

Conventional amounts of the bleach activators may be used e.g. 1% to 30% by weight, 1.2% to 20% by weight, 1.5% to 10% by weight or 2% to 8% by weight, of the inventive composition or unit dose product.

Oxidation Catalysts

Some non-limiting examples of oxidation catalysts that may be used in the compositions described herein include manganese oxalate, manganese-(II)-acetate, manganese-(II)-collagen, cobalt-amine catalysts and the manganese-triazacyclononane (TACN) catalyst (bis(N,N,N-trimethyl-1,4,7-triazacyclononane)-trioxo(hexaflurophosphate))dimanganese(IV).

The skilled person will be aware of other oxidation catalysts that may be successfully combined with the compositions described herein.

Co-Builder

In addition to the MGDA builder, the inventive composition may further comprise one or more additional builder compounds as are known in the art. Alternatively or in addition, a co-builder may be present in another composition forming part of the inventive unit dose product.

A suitable co-builder may be, for example, a citrate salt, preferably sodium citrate, or a phosphonate builder.

Other suitable builders are described in U.S. Pat. No. 6,426,229, which are incorporated by reference herein. Particular suitable builders include; for example, aspartic acid-N-monoacetic acid (ASMA), aspartic acid-N,N-diacetic acid (ASDA), aspartic acid-N-monopropionic acid (ASMP), N-(2-sulfomethyl)aspartic acid (SMAS), N-(2-sulfoethyl)aspartic acid (SEAS), N-(2-sulfomethyl)glutamic acid (SMGL), N-(2-sulfoethyl)glutamic acid (SEGL), N-methyliminodiacetic acid (MIDA), glutamic acid diacetic acid (GLDA), 13-alanine-N,N-diacetic acid (13-ALDA), serine-N,N-diacetic acid (SEDA), isoserine-N,N-diacetic acid (ISDA), phenylalanine-N,N-diacetic acid (PHDA), anthranilic acid-N,N-diacetic acid (ANDA), sulfanilic acid-N,N-diacetic acid (SLDA), taurine-N,N-diacetic acid (TUDA) and sulfomethyl-N,N-diacetic acid (SMDA) and alkali metal salts or ammonium salts thereof, preferably the sodium salts thereof.

Further preferred succinate compounds are described in U.S. Pat. No. 5,977,053 and have the formula;

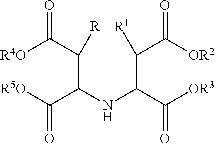

in which R and R¹, independently of one another, denote H or OH; and R², R³, R⁴, and R⁵, independently of one another, denote a cation, hydrogen, alkali metal ions or ammonium ions having the general formula R⁶R⁷R⁸R⁹N⁺, wherein R⁶, R⁷, R⁸, and R⁹, independently of one another, denote hydrogen, alkyl radicals having 1 to 12 C atoms, or hydroxyl-substituted alkyl radicals having 2 to 3 C atoms.

Preferred examples include tetrasodium imminosuccinate. Iminodisuccinic acid (IDS) and (hydroxy)iminodisuccinic acid (HIDS) and alkali metal salts or ammonium salts thereof are especially preferred succinate based builder salts.

Polymers intended to improve the cleaning performance of the detergent compositions may also be included therein. For example, sulphonated polymers may be used. Preferred examples include copolymers of CH₂═CR¹—CR²R³—O—C₄H₃R⁴—SO₃X wherein R¹, R², R³, R⁴ are independently 1 to 6 C alkyl or hydrogen, and X is hydrogen or alkali, with any suitable other monomer units including modified acrylic, fumaric, maleic, itaconic, aconitic, mesaconic, citraconic and methylenemalonic acid or their salts, maleic anhydride, acrylamide, alkylene, vinylmethyl ether, styrene and any mixtures thereof. Other suitable sulfonated monomers for incorporation in sulfonated (co)polymers are 2-acrylamido-2-methyl-1-propanesulphonic acid, 2-methacrylamido-2-methyl-1-propanesulphonic acid, 3-methacrylamido-2-hydroxy-propanesulphonic acid, allysulphonic acid, methallysulphonic acid, 2-hydroxy-3-(2-propenyloxy)propanesulphonic acid, 2-methyl-2-propenen-1-sulphonic acid, styrenesulphonic acid, vinylsulphonic acid, 3-sulphopropylacrylate, 3-sulphopropylmethacrylate, sulphomethylacrylamide, sulphomethylmethacrylamide and water soluble salts thereof. Suitable sulphonated polymers are also described in U.S. Pat. No. 5,308,532 and in WO 2005/090541.

A preferred polymer is an acrylic based sulphonic copolymer such as Acusol™ 588 available from The Dow Chemical Company (in powder form—Acusol™ 588 D—or granular form—Acusol™ 588 G).

It is preferred to avoid phosphate-containing builders, or at least minimize the amount of these builders required. But if phosphate-containing builders are also to be used it is preferred that mono-phosphates, di-phosphates, tri-polyphosphates or oligomeric-polyphosphates are used. The alkali metal salts of these compounds are preferred, in particular the sodium salts. An especially preferred phosphate builder is sodium tripolyphosphate (STPP).

In an embodiment, the composition of the present invention is phosphate-free, or phosphorus-free (i.e. free of phosphates, phosphonates, and other P-containing ingredients). In an embodiment, the unit dose product of the invention is phosphate-free, or phosphorus-free.

In an embodiment, the total builder quantity in the composition of the invention, or the total builder quantity in the unit dose product of the invention, is 5% to 95% by weight, preferably 15% to 75% by weight, preferably 25% to 65% by weight, most preferably 30% to 60% by weight of the detergent composition.

Enzymes

The compositions described herein may comprise one or more enzymes. Desirably the enzyme(s) are present in the inventive composition, or in the inventive unit dose product, in an amount of 0.01% to 6% by weight, especially 0.02% to 5% by weight, when added as a commercial preparation. As they may not be 100% active preparations, this may represent a lower equivalent amount of pure enzyme, for instance 0.005% to 2% of pure enzyme(s).

Any type of enzyme conventionally used in detergent compositions may be used according to the present invention. It is preferred that the enzyme is selected from proteases, lipases, amylases, cellulases, pectinases, laccases, catalases and all oxidases or combinations thereof, with proteases and amylases being preferred. Any suitable species of these enzymes may be used as desired.

pH Modifier

The compositions described herein may comprise a source of acidity or a source of alkalinity to obtain the desired pH on dissolution in water, in the course of a washing or cleaning operation. A source of acidity may be any suitable acidic compound, e.g. a polycarboxylic acid such as citric acid. A source of alkalinity may be any suitable basic compound e.g. a carbonate or bicarbonate, such as an alkali metal or alkaline earth metal carbonate or bicarbonate. In an embodiment, the inventive composition, or the inventive unit dose product, contains an alkalinity source.

Auxiliaries

The compositions described herein may comprise other auxiliary agents as required, in conventional amounts, such as anti-corrosion agents (e.g. silver/copper anti-corrosion agents like benzotriazole and substituted derivatives thereof such as tolyltriazole), anti-foam agents, preservatives and fragrances.

### EXAMPLES

The invention is further demonstrated by the following non limiting examples.

The following base gel detergent formulations were prepared:

TABLE 1

| Comparative Examples - Aqueous gel | | Examples - Non-aqueous gel | |
|---|---|---|---|
| | % by | | % by |
| Ingredient | weight | Ingredient | weight |
| Trilon ™ M powder | 48 | Trilon ™ M powder | 48 |
| Acusol ™ 588D | 6 | Acusol ™ 588D | 6 |
| PEG 6000 | 0.3 | PEG 6000 | 0.3 |
| Water | 42 | — | — |
| — | — | Genapol ™ EP 2584 | 31 |
| — | — | Polyglycol P41/12000 | 10 |
| — | — | Antifoam SE 36 | 1 |
| Minor ingredients | balance | Minor ingredients | balance |

1% of each the following colourant solutions was then incorporated into the base gel formulations in turn (solution concentrations were chosen to achieve equivalent colour intensities of the resulting formulations). The samples were stored for 7 days at 50° C. under ambient humidity conditions. Colour stability was graded according to a 1 to 5 scheme where 1 is a significant colour change and 5 is no colour change. The results set out in Table 2 below show that a wide range of different colourants are much more stable in non-aqueous MGDA-containing gels than the corresponding aqueous gels.

TABLE 2

| | | Stability | Stability | |
|---|---|---|---|---|
| Comparative | | of | of non- | |
| Example/ | | aqueous | aqueous | |
| Example No. | Colourant | gel | gel | Comments |
| 1 | Sanolin ™ Blue | 2 | 5 | White areas could |
| | NBL (1.06% in | | | be seen in the |
| | 1,2 propylene | | | aqueous gel after |
| | glycol) | | | storage |
| 2 | Lanasyn ™ Blue | 2 | 5 | White areas could |
| | F-2RFL (15% in | | | be seen in the |
| | Plurafac LF500) | | | aqueous gel after |
| | | | | storage |
| 3 | Iragon ™ Blue | 1 | 5 | The aqueous gel |
| | ABL 9 (2% in | | | had turned almost |
| | 1,2 propylene | | | completely white |
| | glycol) | | | after storage |
| 4 | Sanolin ™ | 2 | 5 | White areas could |
| | Green R-3GL | | | be seen in the |
| | (5% in 1,2 | | | aqueous gel after |
| | propylene | | | storage |
| | glycol) | | | |
| 5 | Sanolin ™ | 1 | 5 | Numerous large |
| | Ponceau 4RC | | | white/yellow areas |
| | 82 (2% in | | | could be seen in the |
| | 1,2 propylene | | | aqueous gel after |
| | glycol) | | | storage |
| 6 | Ariabel ™ | 2 | 5 | White areas could |
| | Rubicon | | | be seen in the |
| | (15% in | | | aqueous gel after |
| | 1,2 propylene | | | storage |
| | glycol) | | | |

Corresponding solid formulations to the aqueous gel formulations, containing 41.9% soda instead of water, all degenerate into a wet compact upon storage, often accompanied by a colour change too.

1. A non-aqueous liquid, gel or paste composition, comprising a colourant and methylglycine diacetic acid or a salt thereof.

2. The composition as claimed in claim 1, wherein said methylglycine diacetic acid or salt thereof is in a dispersed phase.

3. The composition as claimed in claim 2, wherein said methylglycine diacetic acid or salt thereof is in the form of uncoated, dispersed particles.

4. The composition as claimed in claim 3, wherein any co-granulant or excipient in said particles makes up no more than 10% of their weight.

5. The composition as claimed in claim 3, wherein said particles comprise powder particles of methylglycine diacetic acid or a salt thereof.

6. The composition as claimed in claim 1, wherein the colourant is an organic species and/or a dye.

7. The composition as claimed in claim 1, wherein the colourant is hydrophilic.

8. The composition as claimed in claim 1, wherein the colourant comprises a metal ion.

9. The composition as claimed in claim 1, which does not comprise bleach.

10. The composition as claimed in claim 1, comprising 5% to 95% by weight methylglycine diacetic acid or salt(s) thereof.

11. (canceled)

12. The composition as claimed in claim 1, wherein the composition is a detergent composition.

13. A unit dose detergent product comprising the composition as claimed in claim 1.

14. A washing or cleaning process that utilizes the composition as claimed in claim 1.

15. Use of the composition as claimed in claim 1 for washing or cleaning.

16. The composition as claimed in claim 12, wherein the composition is an automatic machine dishwashing detergent composition.

17. The unit dose detergent product as claimed in claim 13, wherein the product is an automatic machine dishwashing product.

18. The washing or cleaning process as claimed in claim 14 being an automatic machine dishwashing process.

19. The use as claimed in claim 15 for automatic machine dishwashing.

20. A composition comprising:
a colorant; and
methylglycine diacetic acid or a salt thereof;
wherein the state of the composition is selected from the group consisting of a non-aqueous liquid, gel and paste; and
wherein the composition comprises 45% to 55%, by weight methylglycine diacetic acid or salt(s) thereof.
